(19) United States
(12) Patent Application Publication
(10) Pub. No.: US 2021/0373562 A1
(43) Pub. Date: Dec. 2, 2021

(54) SYSTEM AND METHOD FOR IMPROVED BOUNDARY DETECTION FOR ROBOTIC MOWER SYSTEM

(71) Applicant: R-Go Robotics LTD., Caesarea (IL)

(72) Inventors: Amir BOUSANI, Kadima (IL); Nizan HORESH, Caesarea (IL)

(73) Assignee: R-Go Robotics LTD., Caesarea (IL)

(21) Appl. No.: 17/331,180

(22) Filed: May 26, 2021

Related U.S. Application Data
(60) Provisional application No. 63/030,587, filed on May 27, 2020.

(51) Int. Cl. G05D 1/02; G06K 9/00; A01D 34/00

(52) U.S. Cl. CPC G05D 1/0212; G06K 9/00664; A01D 2101/00; G05D 1/0234; G05D 2201/0201; A01D 34/008

(57) ABSTRACT

A system and method for perimeter detection. A method includes exploring an area defined by a first boundary, wherein the exploration includes causing a robotic device to navigate and capture sensor signals within the area defined by the first boundary; determining a second boundary based on the sensor signals captured during the exploration, wherein the second boundary defines an outermost area for actions by a robotic device; and causing the robotic device to perform actions within the first boundary and along the second boundary.

### CROSS-REFERENCE TO RELATED APPLICATIONS

This application claims the benefit of U.S. Provisional Application No. 63/030,587 filed on May 27, 2020, the contents of which are hereby incorporated by reference.

### TECHNICAL FIELD

The present disclosure relates generally to robotic control systems and, more specifically, to robot guidance and perimeter detection systems using perception.

### BACKGROUND

As increasingly-prevalent robotics technology continues to improve various aspects of day-to-day life, the implementation of robotic lawnmowers and similar tools may present a welcome innovation. Robotic lawnmowers may be of interest to greenskeepers, landscapers, government maintenance departments, and other similar operators tasked with maintaining the lawns of houses, office buildings, city parks, golf courses, and others. Robotic lawnmowers may allow for the reduction or elimination of human operators, allowing for reduced labor costs, greater employee availability, and more reliable performance. Furthermore, robotic lawnmowers may be particularly well-suited to tasks which would be difficult for human operators, such as nighttime mowing, thereby allowing for greater flexibility in the scheduling and use of the mowed land.

Current robotic lawnmower systems typically operate using a common principle of boundary definition. By defining the boundaries of the area to be mowed by a robot, the robot's operator can configure a perimeter in which the robotic lawnmower will remain. In many cases, the robotic lawnmower may be trained to move close to the boundary in a defined, repetitive path. While the definition of a boundary is critical to the operation of a robotic lawnmower, present boundary definition systems may be less than ideal for certain conditions or applications.

A major difficulty in implementing a robotic lawn mowing subsystem occurs when defining the boundaries beyond which the robot will not pass. Some existing solutions require installing a boundary wire implanted in the ground around the perimeter. While the buried-wire solution is effective in defining a bounded area, such a solution fails to meet the needs of certain operators who wish to use a robotic mower but are unable to implement a boundary wire. The labor cost of installing a boundary wire may be unpalatable for some homeowners or may be prohibitively expensive for owners of larger tracts, such as city parks and golf courses. Further, installation of a boundary wire may not be feasible in rocky soil or difficult terrain, through dense forests, or in other similar circumstances.

As an alternative to wire-based guidance and boundary-definition, wireless positioning systems may be applicable to robotic mower systems. These systems may allow a robotic mower to locate itself within a tract of land, to receive operating instructions and virtual boundaries, and to navigate without the need to install a wire guide. However, wireless guidance systems lack the precision necessary to cut lawns to the required tolerances and to avoid obstacles, repeatably, across various lawns and conditions, over the lifecycle of the system.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for wireless perimeter detection. The method comprises: exploring an area defined by a first boundary, wherein the exploration includes causing a robotic device to navigate and capture sensor signals within the area defined by the first boundary; determining a second boundary based on the sensor signals captured during the exploration, wherein the second boundary defines an outermost area for actions by a robotic device; and causing the robotic device to perform actions within the first boundary and along the second boundary.

Certain embodiments disclosed herein also include a non-transitory computer readable medium having stored thereon causing a processing circuitry to execute a process, the process comprising: exploring an area defined by a first boundary, wherein the exploration includes causing a robotic device to navigate and capture sensor signals within the area defined by the first boundary; determining a second boundary based on the sensor signals captured during the exploration, wherein the second boundary defines an outermost area for actions by a robotic device; and causing the robotic device to perform actions within the first boundary and along the second boundary.

Certain embodiments disclosed herein also include a system for wireless perimeter detection. The system comprises: a processing circuitry; and a memory, the memory containing instructions that, when executed by the processing circuitry, configure the system to: explore an area defined by a first boundary, wherein the exploration includes causing a robotic device to navigate and capture sensor signals within the area defined by the first boundary; determine a second boundary based on the sensor signals captured during the exploration, wherein the second boundary defines an outermost area for actions by a robotic device; and cause the robotic device to perform actions within the first boundary and along the second boundary.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1 is a schematic diagram illustrating the components of a robotic mower system according to an embodiment.

FIG. 2 is a flowchart illustrating a method for defining boundaries for robotic mower operations according to an embodiment.

FIG. 3 is an illustration demonstrating a safety boundary according to an embodiment.

FIG. 4 is an illustration demonstrating the fine-tuning of a precision boundary over a safety boundary according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In light of the above-noted challenges, it has been identified that wireless perimeter definition solutions would be desirable. To this end, the disclosed embodiments provide techniques that allow for perimeter detection that is wireless and therefore does not require installation of a boundary wire. The disclosed embodiments further include improvements to such wireless perimeter detection techniques that allow for, among other things, fine tuning any detected perimeters in order to improve accuracy and precision of boundary definition and, consequently, of navigating based on defined boundaries.

It has also been identified that many robotic systems have adequate positioning sensors but that, for various reasons, signals captured by those positioning sensors may not be entirely accurate and may lack the precision needed to successfully mow every last inch of grass (i.e., some portions of grass which should be mowed may be missed due to lack of precision). In particular, some uses require mowing areas of grass that requires precision at the centimeter level, and various uses in which a robot operates in different lawns or a lawn whose landscape changes slightly over months and years. As a result of these and other issues, inaccurate positioning signals may result in the robot moving and/or acting outside of the permissible area of operation.

The various disclosed embodiments include a method and system for improved wireless perimeter detection. In an embodiment, perimeter detection is implemented in a robotic device configured for real-world actions to be constrained by certain boundaries such as a robotic mower system.

A first safety boundary is set for the robotic device. The safety boundary defines the initial permissible bounds of operation for the robotic mower system which ensures safe operation and includes at least points defining the contours of the safety boundary and an accepted margin. Exploration is performed based on the safety boundary in order to determine a second precision boundary. The precision boundary may be fine-tuned once exploration is complete in order to more precisely define the edges of the precision boundary, thereby maximizing the amount of area which can be effectively covered by the robotic device. A robotic device navigates and acts based on the safety and precision boundaries. Specifically, the robotic device moves and acts within the safety boundary, and the robotic device moves and acts along the precision boundary.

The safety boundary may be set based on user inputs, sensor signals captured by a robotic mowing system, a combination thereof, and the like. The accepted margin may be predetermined or set based on user inputs and may be, but is not limited to, a distance beyond the safety boundary which the robotic device is permitted to navigate.

The exploration includes navigating within the area in and around the safety boundary (e.g., the area within the safety boundary) and generating an internal map representing the explored area. The internal map may be generated based on images and other signals captured by the robotic device during the navigation. Based on such images and other signals, features which define the operation boundary are identified. Such features may include, but are not limited to, physical bounds which block movement by the robotic device, physical bounds which do not block movement by the robotic device, and virtual bounds.

Acting both within a safety boundary and along a precision boundary as described herein allows for more precisely defining the edges of territory in which a robotic device operates as compared to existing wireless solutions without requiring deployment of a boundary wire or other physical device used to precisely define the outer boundary. Further, use of the safety boundary during initial exploration helps to ensure that the robotic device is not damaged and does not cause harm during the exploration.

In accordance with various disclosed embodiments, the safety boundary may be defined roughly without requiring excessive user input and subsequently relaxed based on a permissible margin, thereby establishing the general area in which the robot should operate. The precision boundary is defined more precisely using more specific inputs, thereby establishing the precise outer bounds of the area in which the robot should operate. Accordingly, the robotic device may operate freely within the safety boundary (for example, using a default algorithm of the robotic device for navigating and acting within an area) and may operate in a more constrained fashion along the precision boundary to ensure that the edges of the territory covered by the robotic device's actions are navigated precisely.

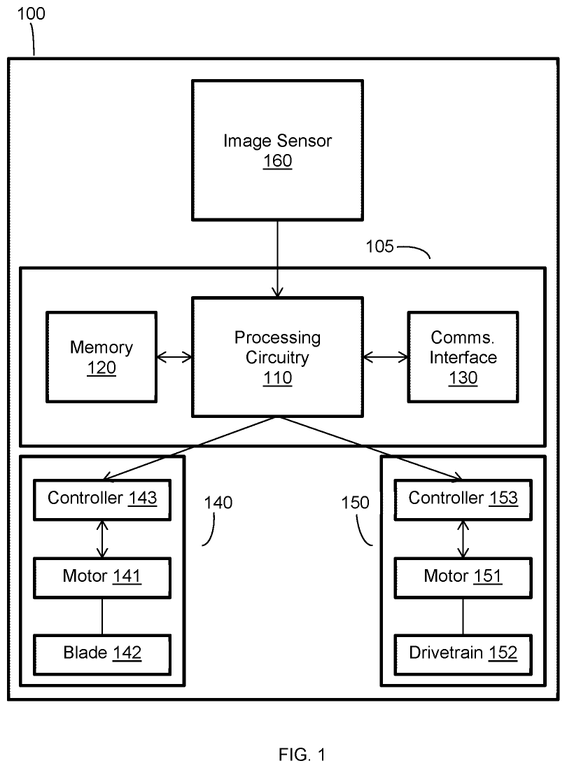

FIG. 1 is a schematic diagram illustrating the components of a robotic mower system 100 according to an embodiment. The robotic mower system 100 includes a boundary controller 105, a mowing subsystem 140, a drive subsystem 150, and an image sensor 160. The boundary controller 105 includes a processing circuitry 110, a memory 120, and a communications (comms.) interface 130.

In an embodiment, the processing circuitry 110 may comprise or be a component of a processor (not shown) or an array of processors coupled to the memory 120. The memory 120 contains instructions that can be executed by the processing circuitry 110. The instructions, when executed by the processing circuitry 110, cause the processing circuitry 110 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The memory 120 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The communications interface 130 allows for communication between the robotic mower system 100 and a user device (not shown) and may include, but is not limited to, a receiver, hub, or other component configurable to receive communications from or transmit communications to the robotic mower system 100. Such a user device may be, but is not limited to, a smartphone, a tablet computer, or other mobile device, a personal computer, a controller specifically adapted to send communications to, receive communications from, or both send and receive communications to and from the robotic mower system 100, and the like.

In an embodiment, the communications interface 130 may allow for communication between the robotic mower system 100 and the user device using communications protocols including, without limitation, Bluetooth, Wi-Fi, Ethernet, BLE, USB, NFC, ISM-band radio, other communication protocols, and the like.

The communications interface 130 may allow the robotic mower system 100 to receive communications including, without limitations, commands, schedules, status checks, measurement requests, and the like, and to store the received communications in the memory 120 for, when applicable, use by the processing circuitry 110. The communications interface 130 may allow the robotic mower system 100 to send communications to a user device including, without limitation, system status updates, mowing statistics, relevant measurements, and other like information.

The mowing subsystem 140 includes components relevant to the mowing operation and may include mechanical components, electronic components, or both. In an embodiment, the mowing subsystem 140 includes a mow motor 141, a blade 142, and a mow controller 143 that is communicatively connected to the processing circuitry 110. The connection between the mow controller 143 and the processing circuitry 110 may allow the mow controller 143 to receive instructions, commands, and other signals directing the operation of the mowing subsystem 140. In addition, the mow controller 143 may be electronically connected to the mow motor 141, thereby allowing the mow controller 143 to direct the motion of the mow motor 141. Furthermore, the blade 142 may be mechanically connected to the mow motor 141, thereby allowing the blade 142 to turn with the action of the mow motor 141. The blade 142, in turn, is installed in or on hardware components of the robotic mower system 100 and is adapted to cut grass when turned via the mow motor 141.

In some implementations (not shown), the mow controller 143 may be integrated with the processing circuitry 110, thereby allowing for a direct electrical connection between the processing circuitry 110 and the mow motor 141. Such implementations allow for control of the mow motor 141 and, thus, the blade 142, by the processing circuitry 110.

The drive subsystem 150 includes components relevant to the navigation of the robotic mower system 100 and may include electrical components, mechanical components, or a combination thereof. In an embodiment, the drive subsystem 150 includes a drive motor 151, a drivetrain 152, and a drive controller 153 communicatively connected to the processing circuitry 110.

The connection between the drive controller 153 and the processing circuitry 110 may allow the drive controller 153 to receive instructions, commands, and other signals directing the operation of the drive subsystem 150. In addition, the drive controller 153 may be electrically connected to the drive motor 151, thereby allowing the drive controller 153 to direct the motion of the drive motor 151. Furthermore, the drivetrain 152 may be mechanically connected to the drive motor 151, thereby allowing the drivetrain 152 to turn with the action of the drive motor 151. The drivetrain 152 transmits torque from the motor to the ground beneath the robotic mower system 100, thereby allowing the robotic mower system 100 to move. The drivetrain 152 may be constructed from parts including, without limitation, wheels, treads, driveshafts, belts, chains, pulleys, gears, combinations thereof, and the like.

In an embodiment (not shown), the drive controller 153 may be integrated with the processing circuitry 110, thereby allowing for a direct electrical connection between the processing circuitry 110 and the drive motor 151. This allows for control of the drive motor 151 and, consequently, of the drivetrain 152, by the processing circuitry 110.

In an embodiment (not shown), the drive motor 151 and the mow motor 141 may be the same motor and is capable of providing power to both the drivetrain 152 and the blade 142 at the same time.

The image sensor 160 is configured to acquire images of the scene pertinent to motion (e.g., the scene showing the environment in which the robotic mower system 100 moves and cuts grass). The image sensor 160 may include, but is not limited to, an infrared sensor, a complementary metal-oxide-semiconductor (CMOS) image sensor, or any other type of image sensor. In some embodiments (not shown), multiple image sensors are deployed in different locations within the robotic mower system 100.

Optionally, the robotic mower system 100 may include one or more dedicated image sensors (not shown) configured to gather environmental data pertinent to motion or mowing operations. As a non-limiting example, an image sensor may be dedicated to capturing images of grass which can be used to make decisions about where to mow. As another non-limiting example, an image sensor may be an infrared image sensor configured to capture images which can be used to identify infrared signals such as, but not limited to, infrared signals emitted by a signal beacon as described further below.

In an embodiment, the robotic mower system 100 is configured to establish a mowing boundary based on the images captured by the image sensor 160 as described in greater detail below. The captured images are analyzed to create a visual mapping of a mowing area, including visual boundary indications based on either user inputs or the presence of obstacles shown in the captured images, thereby allowing a bounded area to be explored, mapped, and stored, for example, in the memory 120 or a storage (not shown).

In a further embodiment, the captured images may be applied to establish a safety boundary also as discussed in greater detail below. The safety boundary may be constructed using the images captured by the image sensor 160, including data concerning visually-detectable obstacles, discontinuities in grass, signal beacons, and static visual tags.

In an embodiment, signal beacons (not shown) may be placed at the edges of a safety boundary to alert the robotic mower system 100 not to proceed past the signal beacons. By emitting an infrared signal, the beacon may be detectable by the image sensor 160. Alternatively, or collectively, static visual tags (not shown) may be deployed to similar effect, thereby allowing the robotic mower system 100 to identify the tags using a sensor configured to detect light in the human visual range, in order to establish a safety boundary.

In an embodiment, the beacon is activated by the mowing subsystem 140. In such an embodiment, the mowing subsystem 140 is configured to switch the beacon to illuminate when the mowing subsystem 140 is in a close proximity to the beacon. Once the beacon is active (i.e., emitting light), the mowing subsystem 140, and in particular the image sensor 160 can synchronize to the beacon. The synchronization allows the mowing subsystem 140 to position itself in the space. In some configurations, the exact time and duration to activate the beacon are set by the mowing subsystem 140. Further, the mowing subsystem 140 determines the exposure duration of the image sensor 160.

The synchronization between the beacon and image sensor 160 may be achieved using a communication channel such as, but not limited to, a radio frequency signal. For example, the synchronization may be by means of a Wi-Fi signal, a Bluetooth low energy (BLE) signal, and the like.

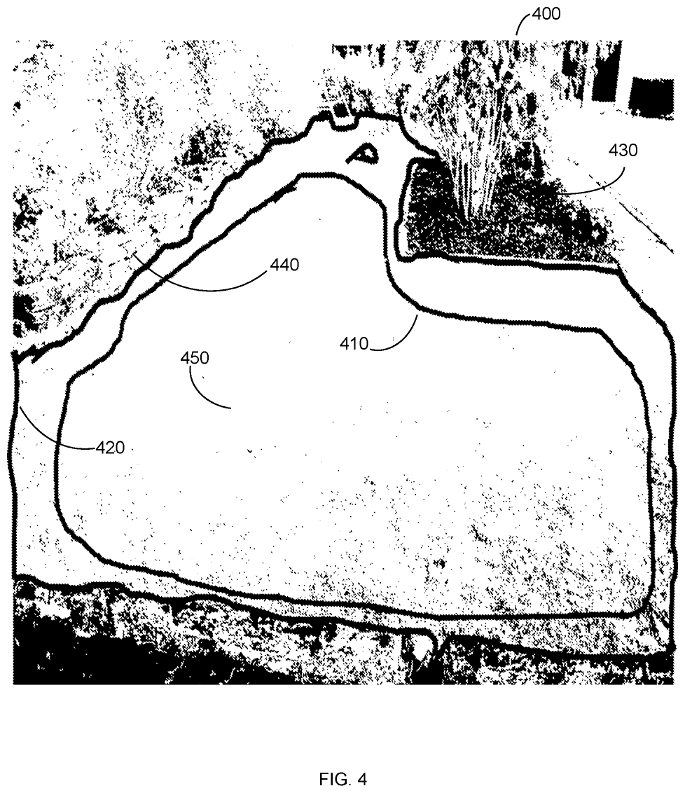

In an additional embodiment, the sensor data collected by the image sensor 160 may be applied to fine-tune boundary edges, for example as described with respect to FIG. 4. As depicted in FIG. 4 and discussed further below, boundary edges may be fine-tuned by including variations on the safety boundary in the robotic mower system's programmed route.

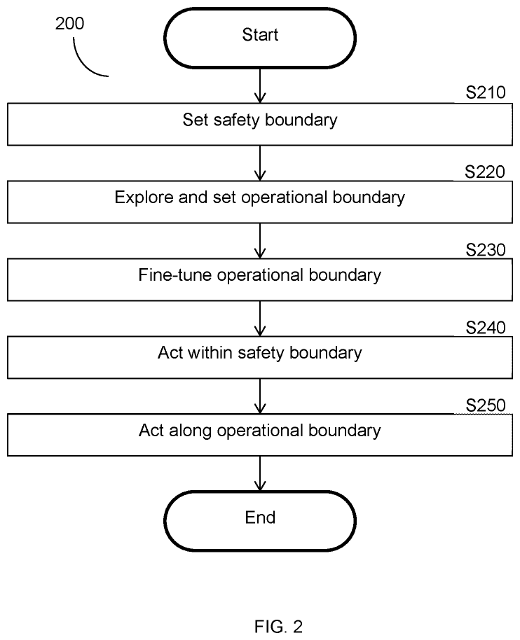

FIG. 2 is an example flowchart 200 illustrating a method for defining boundaries for robotic mower operations according to an embodiment. In an embodiment, the method is performed by the robotic mower system 100, FIG. 1. More specifically, the method may be performed by the boundary controller 105.

At optional S210, a safety boundary is set as a first boundary, thereby allowing for recording of the precision boundary safely (e.g., without causing accidents or other issues). In some embodiments, the safety boundary may be defined by a user. In such an embodiment, user inputs may be received, and the safety boundary is determined based on the user inputs such that the robotic mower system will not move more than a threshold distance beyond the safety boundary. The user inputs may further indicate a margin to be used as such a threshold distance.

Alternatively, or collectively, the safety boundary may be determined based on sensor signals captured by the robotic mowing system. As a non-limiting example, the sensor signals may be captured while the robotic mowing system navigates based on navigation or control signals received from a user device or remote control operated by a user who directs the robotic mowing system to move toward the desired safety boundary, and the safety boundary is determined based on the locations to which the robotic mowing system navigated. As another non-limiting example, the safety boundary may be determined based on visual markers such as a signal beacon or visual tags.

As a non-limiting example for a definition of a safety boundary, a user may define the safety boundary as a 10-meter by 10-meter square, with a margin of 50 centimeters. In such an example, the robotic mower system would mow autonomously within the 100 square meter region and would not cross any of the borders by more than 50 centimeters.

At S220, exploration is performed in order to determine a precision boundary to be set as a second boundary. The precision boundary defines the outermost area for actions in which the robotic mowing system should operate, namely, the edges of the area to be acted upon. In an embodiment, the area within each precision boundary is learned and the internal map is generated. The map may include positioning information such as, without limitation, visual information, magnetic sensor data, RF sensor data, GPS data, other like information, and any combination thereof.

In an embodiment, S220 further includes navigating within an area determined based on the safety boundary and recording data captured by sensors of the robotic device during the navigation. The navigation may be performed according to a predetermined exploration algorithm defining the parameters for moving and capturing data during the exploration, and may include moving within the safety boundary. Based on the captured data, a map of the territory is generated. The precision boundary may be initially set based on the outer bounds observed by the robotic device during exploration.

At S230, the precision boundary is fine-tuned. The precision boundary may be fine-tuned based on coordinates defining the contours of the precision boundary, visual markers used to establish the contours of the precision boundary, physical and/or virtual bounds encountered during exploration, or a combination thereof.

In an embodiment, S230 includes receiving a set of coordinates defining a path, guiding the robotic device to the specific path defined by the coordinates, and determining the precise contours of the precision boundary based on the guidance. The received set of coordinates may be sent from a user device.

In another embodiment, visual markers may be placed along the precision boundary or in known locations with respect to the precision boundary. In such an embodiment, during exploration, the robotic device captures images showing the area in which it navigates. Based on those images, the visual markers may be identified. The positions of the visual markers are determined with respect to the internal map and used to determine the precise contours of the precision boundary. Non-limiting example visual markers may include, but are not limited to, temporary lines marked on a surface (e.g., a line marked on grass using paint, foam, powder, spray, etc.), a tag on a stick having a marker which encodes a position of the tag relative to the map, a blinking light, a combination thereof, and the like.

In yet another embodiment, the precision boundary is fine-tuned based on bounds in the area encountered during the exploration such as, but not limited to, physical bounds which block movement by the robotic mowing system, physical bounds which do not block movement by the robotic mowing system, and virtual bounds.

The bounds may be individual points or groups of points defining portions of the lawn or territory which represent areas that, for example, do not need to be acted upon or otherwise to which the robotic device does not need to navigate. More specifically, while navigating in the area (for example, during exploration), features of bounds encountered during the navigation (i.e., the aforementioned physical or virtual bounds) are recorded in order to more accurately define the outer edges of the area in which the robotic device operates. The precision boundary is fine-tuned based at least on these recorded features.

Physical bounds which block movement by the robotic mowing system may be, but is not limited to, a wall, fence, or other boundary which physically prevents the robotic mowing system from moving. For such a boundary, the robotic mowing device may be configured to move as close as possible without colliding with the boundary.

In another embodiment, a machine learning model may be trained to classify features of the lawn as either walls or not walls, and the machine learning model may be applied to images captured by the robotic device to identify any walls encountered during navigation as physical bounds which block movement. Such continuous obstacles may include, but are not limited to, concrete or other material walls, curbs, rock walls (i.e., a “wall” formed by a series of adjacent rocks), garden edging, and any other continuous solid dividers that define the edge of the lawn. Such a machine learning model may be trained based on training images including images showing different types of walls.

Physical bounds that do not block movement by the robotic mowing system may be, but is not limited to, pavement, the end of a patch of grass or lawn, a point at which the height of the ground drops, and the like. For such a boundary, the robotic mowing system may be configured to move to and possibly through the boundary as long as such movement would not cause a collision with any obstacles or go outside of the limits defined by the safety boundary.

In an embodiment in which the physical bounds which do not block movement used for determining the precision boundary include the end of a patch of grass, such physical bounds may be detected using images captured by the robotic device. In a further embodiment, identifying such physical bounds further includes applying a machine learning model trained using training images depicting grass that is trained to classify areas into either grass or not grass. When a portion of a lawn is detected as grass and, at some point during navigation, images showing a new material along the ground are determined as not showing grass, movement of the robotic device may cease before entering the area that is not grass. In this regard, it has been identified that the colors and other aspects of appearance of grass differ from other types of materials and this distinction can be used to identify these types of physical bounds which are indicative of areas that should not be mowed, thereby further improving the precision of the actions by the robotic device.

Virtual bounds may be, but are not limited to, bounds defined with respect to geography which lack distinct physical characteristics. As non-limiting examples, such virtual bounds may include a line in a contiguous patch of grass that lies along the property line defining the border between one owner's property and the next, a line defining the end of one robot's territory for mowing (for example, when multiple robotic mowing systems are deployed, each may be responsible for mowing a respective predefined area), both, and the like. For such boundaries, the robotic mowing device may be configured to move to the boundary, and may further be either permitted to or forbidden from moving past the boundary as long as such movement would not cause a collision with any obstacles or go outside of the limits defined by the safety boundary. The virtual bounds may be predetermined, and may be based on user inputs.

Once the boundaries have been set as described above, the robotic device can navigate the perimeter to cover the enclosed area fully or partially. The navigation may be through random paths or fixed patterns. Furthermore, during normal operation, the system may follow the precision boundary specified at S230 to mow the edges of the specified territory.

It should be noted that, at least in some implementations, the outermost bounds defined by the safety boundary and any applicable margin (e.g., points along a boundary that are at the margin distance from points along the safety boundary) may be treated as virtual bounds for purposes of establishing the precision boundary.

At S240, actions are taken with respect to the safety boundary. In an embodiment, S240 includes moving and acting within the safety boundary. In another embodiment, S240 may include causing an external robotic device to move and act within the safety boundary (e.g., by sending instructions from a server). At S250, actions are taken with respect to the precision boundary. In an embodiment, S240 includes moving and acting along the precision boundary. In another embodiment, S250 may include causing an external robotic device to move and act along the precision boundary (e.g., by sending instructions from a server).

The actions taken may vary depending on the use case. In an example implementation, the actions taken include navigating and mowing. As a non-limiting example, the robotic device mows in an area within the safety boundary as well as along the precision boundary.

As noted above, by acting along a precision boundary as described herein, the precision of any actions such as mowing based on such a precision boundary are improved, thereby resulting in better performance of the robotic device for uses such as, but not limited to, mowing lawns. More specifically, in the mowing use case, the robotic device moves freely when mowing within the safety boundary to mow the entire area within the safety boundary, and the robotic device also moves exactly along the precision boundary to ensure that the edges of the area to be mowed are covered precisely. This improved precision allows the robotic device to cover more of the area which is supposed to be mowed without exceeding safety boundaries or other constraints. Such improved precision may further result in conserving resources such as fuel or power that would otherwise be wasted by mowing undesirable areas.

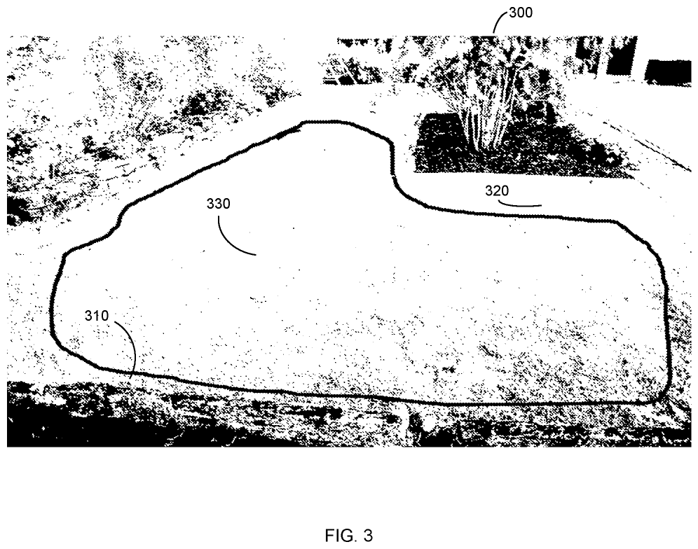

FIG. 3 is an example illustration 300 demonstrating a safety boundary according to an embodiment. In FIG. 3, a safety boundary 310 defines a no-go zone 320 within a tract of land 330 such that travel outside the safety boundary 310 beyond a certain distance is prohibited. As noted above, a user may define one or more distances for allowed travel beyond the safety boundary 310. As an example, the safety boundary 310 may set with a margin such that any travel past 50 centimeters beyond the safety boundary 310 is prohibited. When the safety boundary 310 is defined, the boundary position is recorded. Recording the boundary position may include recording the locations of points along the outline of the boundary on a map utilized by a robotic mowing system (e.g., a map stored in the memory 120 of the robotic mowing system 100, FIG. 1).

In an embodiment, the safety boundary 310 may be defined using methods including, but not limited to, guiding the system along a boundary, pre-loading boundary conditions to the system, guiding the system via remote control, placing markers, such as temporary lines in the grass, visible tags on sticks, electronic signal beacons, and the like. Examples for such methods are described further above.

When the safety boundary 310 has been defined, a robot (e.g., the robotic mowing system 100, FIG. 1) may explore the area within the safety boundary 310 to generate an internal map. The generated internal map may include positioning information such as, but not limited to, vision, magnetic, radiofrequency (RF), global positioning system (GPS), combinations thereof, and the like.

FIG. 4 is an example illustration 400 demonstrating the fine-tuning of a precision boundary over a safety boundary according to an embodiment. In the example illustration 400, an example safety boundary 410 and an example precision boundary 420 are illustrated with respect to a lawn 450. The precision boundary 420 may be a specific variation on one or more segments of the safety boundary 410. The precision boundary 420 may be larger than, smaller than, or equal to the safety boundary 410 for any or all segments of the defined path. The precision boundary 420 defines an edge path describing the precise edges of the portions of the lawn 450 in which mowing should be performed, as well as a path which allows for mowing the edges defined by the precision boundary 420 without incursion into any prohibited zones such as a prohibited zone 430.

In accordance with the disclosed embodiments, the precision boundary 420 may be fine-tuned to account for features resulting from obstacles or other discontinuities such as a discontinuity 440 in the edges defined by the precision boundary 420. The obstacles or discontinuities accounted for may include, but are not limited to, physical bounds blocking the system such as walls or fences; physical barriers which do not block the system such as a height drop, a patch of pavement, or the end of the plot; and virtual bounds such as the property line between a user's property and a neighbor's property.

Where a user wishes to construct the precision boundary in an area including discontinuities in the form of obstacles or other physical barriers which block a robotic mowing system (e.g., the robotic mowing system 100, FIG. 1) such as walls or fences, the precision boundary 420 may be adjusted to account for these physical barriers. Where obstacles block the system's path, a robotic mowing system (e.g., the robotic mowing system 100, FIG. 1) may be configured to automatically generate, or to suggest, path portions which allow the system to mow as close as possible to the boundary 420 in order to maximize the chance that every last inch of grass is mowed without colliding into the obstacles. In another embodiment, the user may manually define the precision boundary 420, thereby creating an edge mowing path to be used as the precision boundary 420 which accounts for the presence of obstacles. Where obstacles block movement by a robot, there is no risk of the robot escaping the precision boundary 420 since it is not physically possible to move past the obstacles.

In an embodiment, where the system is bounded by a physical barrier which the system cannot surpass, the discontinuity 440 to be included in the precision boundary 420 is determined via visual analysis of the discontinuity 440. As obstructive barriers may be recognized by certain characteristics, such as a height which the robotic mowing system cannot surmount, the detection of these features may allow for the automatic creation of a precision boundary 420 abutting the obstacle. The obstacles considered in such a configuration may include, but are not limited to, curbs, rock walls, garden edging, and any solid divider which defines the edge of the lawn.

In the case where the discontinuity 440 is a hazard which does not block the system, such as a patch of pavement, a height drop, or the end of a lawn, the precision boundary 420 may be configured to account for these hazards. As mowing in unsuitable terrain may cause damage to the system from, for example, scraping mower blades on concrete, or a fall from a higher portion of grass, a mowing path which allows for mowing the greatest area safely may be desirable. In an embodiment, the robotic mower system may be configured to automatically generate, or to suggest, path segments which include the furthest safe mowing points, without any passage into zones containing potential discontinuity? 440. As damage may result from entry into zones containing non-blocking hazards and because the system is not physically confined, the risk of the robot escaping and causing harm to itself or to people and property may be considered and appropriate actions to avoid such harm may be taken.

In an example implementation, zones containing non-blocking obstacle discontinuities 440 such as patches of concrete, height drops, and the edges of lawns, may be identified using visual indications. Physical objects acting as visual indicators (not shown) may be placed in the plot to identify no-go zones, and differences in the land over which the system travels may be used as visual indications of a no-go zone. For systems including cameras, temporary or permanent artificial visual markers may allow for the detection of no-go zones at points on the perimeter of the plot, or at pre-defined points. Artificial visual markers may include, but are not limited to, temporary lines marked in the grass using paints, foams, powders, or sprays, a tag staked into the ground including a marker coding the relative position of the boundary, flashing or blinking lights such as lights shining at frequencies outside the visual spectrum, combinations thereof, and the like. In a further example implementation, a flashing light visual indicator may be configured to encode some information regarding the boundary, using the pattern and frequency with which the light flashes. As a non-limiting example, a particular pattern and frequency of flashing lights may correspond to an indication that the no-go zone is a drop in height.

In addition to artificial visual markers, no-go zones may be detected by visual inspection of the land 400 over which the system travels. As the system regards grass mowing, an inspection method which distinguishes grass from other materials may be applied to demarcate no-go zones without requiring temporary or artificial markers. In an embodiment, grass may be identified using neural networks. Further, in an additional embodiment, grass may be detected using color analysis, under the proposition that some colors, such as brick-red, may not be anticipated colors of grass. The detection of a divide between grassy and grassless regions may allow for the creation of boundary lines at the divide and may allow for more accurate boundary path creation.

In an embodiment, detected boundary information is integrated with the system's navigation. That is, the navigation coordinates configured with the system may be augmented with determined boundaries. In an embodiment, this can be achieved by reconstructing the 3D geometry from the camera views. The boundaries can be included in the robot's navigation map. This map can be stored for future operation. In a further embodiment, the map is presented to the user for approval.

For situations where virtual bounds must be established, such as at a property line between a user's land and a neighbor's land, creation of a boundary edge path may allow for more accurate mowing within the boundaries during normal operations. In an embodiment, virtual bounds may be established manually, by user control through a remote or other mechanism. In another embodiment, virtual bounds may be established automatically by means including, but not limited to, analysis of zoning maps to determine property lines, based on user specifications of locations of the boundary via a control interface, and the like. Additionally, virtual bounds may be established by the same methods used to automatically demarcate no-go zones including, without but not limited to, temporary lines marked in grass, installation of stick-and-tag markers, and electronic signals in the visible and invisible spectra.

It should be noted that various disclosed embodiments are described with respect to a robotic mowing system merely for simplicity, but that the techniques described herein may be applicable to robotic devices configured for performing other actions which may require real-world precision in covering areas which need to be constrained via boundaries. As non-limiting examples, such other actions may include, but are not limited to, salting walkways (e.g., for melting snow or ice), trimming hedges, spreading fertilizer, plowing dirt, cleaning floors, and the like.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for wireless perimeter detection, comprising:
exploring an area defined by a first boundary, wherein the exploration includes causing a robotic device to navigate and capture sensor signals within the area defined by the first boundary;
determining a second boundary based on the sensor signals captured during the exploration, wherein the second boundary defines an outermost area for actions by a robotic device; and
causing the robotic device to perform actions within the first boundary and along the second boundary.

2. The method of claim 1, further comprising:
fine-tuning the second boundary.

3. The method of claim 2, further comprising:
causing the robotic device to navigate along a set of coordinates defining a path, wherein the second boundary is fine-tuned based on the navigation along the path.

4. The method of claim 2, further comprising:
identifying a plurality of visual markers deployed with respect to the second boundary that are encountered during the exploration; and
determining a position of each of the visual markers, wherein the second boundary is fine-tuned based on the determined positions.

5. The method of claim 4, wherein each of the plurality of visual markers is any of: a point along a line marked on a surface, a tag including a marker encoding a position of the tag, and a blinking light.

6. The method of claim 2, wherein the second boundary is fine-tuned based on a plurality of bounds encountered during the exploration, wherein each bound is a point representing an area to which the robotic device does not need to navigate.

7. The method of claim 6, wherein the plurality of bounds includes at least one of: physical bounds which block movement by the robotic device, physical bounds which do not block movement by the robotic device, and virtual bounds defined with respect to geography which lack distinct physical characteristics.

8. The method of claim 1, wherein the first boundary includes a plurality of points defining contours of the first boundary and a margin.

9. The method of claim 1, wherein the robotic device is a robotic mowing system, wherein the actions performed by the robotic device including mowing grass.

10. A non-transitory computer readable medium having stored thereon instructions for causing a processing circuitry to execute a process, the process comprising:
exploring an area defined by a first boundary, wherein the exploration includes causing a robotic device to navigate and capture sensor signals within the area defined by the first boundary;
determining a second boundary based on the sensor signals captured during the exploration, wherein the second boundary defines an outermost area for actions by a robotic device; and
causing the robotic device to perform actions within the first boundary and along the second boundary.

11. A system for wireless perimeter detection, comprising:
a processing circuitry; and
a memory, the memory containing instructions that, when executed by the processing circuitry, configure the system to:
explore an area defined by a first boundary, wherein the exploration includes causing a robotic device to navigate and capture sensor signals within the area defined by the first boundary;
determine a second boundary based on the sensor signals captured during the exploration, wherein the second boundary defines an outermost area for actions by a robotic device; and
cause the robotic device to perform actions within the first boundary and along the second boundary.

12. The system of claim 11, wherein the system is further configured to:
fine-tune the second boundary.

13. The system of claim 12, wherein the system is further configured to:
cause the robotic device to navigate along a set of coordinates defining a path, wherein the second boundary is fine-tuned based on the navigation along the path.

14. The system of claim 12, wherein the system is further configured to:
identify a plurality of visual markers deployed with respect to the second boundary that are encountered during the exploration; and
determine a position of each of the visual markers, wherein the second boundary is fine-tuned based on the determined positions.

15. The system of claim 14, wherein each of the plurality of visual markers is any of: a point along a line marked on a surface, a tag including a marker encoding a position of the tag, and a blinking light.

16. The system of claim 12, wherein the second boundary is fine-tuned based on a plurality of bounds encountered during the exploration, wherein each bound is a point representing an area to which the robotic device does not need to navigate.

17. The system of claim 16, wherein the plurality of bounds includes at least one of: physical bounds which block movement by the robotic device, physical bounds which do not block movement by the robotic device, and virtual bounds defined with respect to geography which lack distinct physical characteristics.

18. The system of claim 11, wherein the first boundary includes a plurality of points defining contours of the first boundary and a margin.

19. The system of claim 11, wherein the robotic device is a robotic mowing system, wherein the actions performed by the robotic device including mowing grass.
